(19) United States
(12) Patent Application Publication
(10) Pub. No.: US 2004/0166473 A1
(43) Pub. Date: Aug. 26, 2004

(54) Dental handpiece, torque applying tool for use therewith and dental kit including same

(76) Inventor: Yechiel Cohen, Carmiel (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 10/780,614

(22) Filed: Feb. 19, 2004

(30) Foreign Application Priority Data
Feb. 20, 2003 (IL) 154561

(51) Int. Cl. A61C 3/03

(52) U.S. Cl. 433/105

(57) ABSTRACT

A dental handpiece including a housing of a size and configuration to be conveniently graspable by a user; a dental tool clamping device carried by the housing; a dental tool to be clamped in the clamping device; a rotary drive for rotating the clamping device, and the dental tool when clamped therein; and a transmission system coupling the rotary drive to the dental tool to rotate same. The dental tool includes a driving tip for engaging the head of a fastening member to be fixed by rotation within the patient's mouth. The transmission system includes a torque limiter for limiting the torque applied by the rotary drive to the driving tip. In some described embodiments, the torque limiter is included within the dental housing, and in other described embodiments it is included within the dental tool.

### FIELD AND BACKGROUND OF THE INVENTION

The present invention relates to a dental handpiece for use in fastening members within a patient's mouth. The invention also relates to a torque applying tool for use in such a dental handpiece, and further, to a dental kit including such a dental handpiece and toque applying tool.

Prosthetics, braces, and other dental devices frequently include fastening members to be fixed by rotation within the patient's mouth. At the present time, this is usually done manually by using hand-held Allen keys, screwdrivers, spanners, or the like, which are manually applied to the fastening member and then manually rotated. Fixing fastening members within a patient's mouth in this manner can be particularly awkward and time consuming. In addition, if extreme care is not exercised, excess torque may be inadvertently applied which could result in substantial damage to the patient.

### OBJECTS AND BRIEF SUMMARY OF THE PRESENT INVENTION

An object of the present invention is to provide a dental handpiece which can be used for fixing fastening members within a patient's mouth in a manner which is more convenient and less time consuming to the dentist, and which avoids the danger of damage by the application of excessive torque.

According to one aspect of the present invention, there is provided a dental handpiece, comprising: a housing of a size and configuration to be conveniently graspable by a user; a dental tool clamping device carried by the housing; a dental tool to be clamped in the clamping device, the dental tool being of a size and configuration enabling it to be received in the mouth of the patient and used for performing an operation therein involved in a dental treatment of the patient; a rotary drive for rotating the clamping device, and the dental tool when clamped therein; and a transmission system coupling the rotary drive to the dental tool to rotate same; characterized in that the dental tool includes a driving tip for engaging the head of a fastening member to be fixed by rotation within the patient's mouth; and in that the transmission system includes a torque limiter for limiting the torque applied by the rotary drive to the driving tip.

Several embodiments of the invention are described below for purposes of example. In some described embodiments, the torque limiter is included within the housing between the rotary drive and the dental tool clamping device; and in other described embodiments, the torque limiter is included within the dental tool between its mounting shaft and the driving tip.

As will be described more particularly below, a dental handpiece constructed in accordance with the foregoing features enables the dentist or other dental attendant to fix fastening members in the patient's mouth more conveniently, more speedily, and with less risk of causing damage by excessive torque.

According to another aspect of the present invention, there is provided, a tool for mounting to a housing including a rotary drive, comprising: a driving tip at one end of the tool for engaging the head of a fastening member to be fastened by rotation; a mounting shaft at the opposite end of the tool for mounting to a housing including a rotary drive; and a torque limiter between the driving tip and the mounting shaft for limiting the torque to be applied by the rotary drive to the driving tip.

According to yet another aspect of the present invention, there is provided a dental kit comprising: a housing of a size and configuration to be conveniently grasped by a user; a rotary drive within the housing; a dental tool clamping device carried by the housing and coupled to the rotary drive; and a plurality of different dental tools selectively mountable in the dental tool clamping device for use in various dental treatments of the patient; at least one of the dental tools including a driving tip for engaging the head of a fastening member to be fixed by rotation within the patient's mouth, and a torque limiter for limiting the torque applied by the rotary drive to the driving tip.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a longitudinal sectional view illustrating a dental handpiece constructed in accordance with the present invention;

FIG. 2 is an enlarged fragmentary view of the distal end of the handpiece of FIG. 1;

FIG. 3 is a top plan view of the proximal end of the handpiece of FIG. 1;

FIG. 4 is an enlarged sectional view of the torque limiter in the handpiece of FIG. 1;

FIG. 5 is a sectional view illustrating a torque applicator tool constructed in accordance with the present invention for use in dental handpieces;

FIG. 6 illustrates another torque applicator tool constructed in accordance with the present invention for use in dental handpieces;

FIG. 7 is a longitudinal sectional view illustrating a manually driven dental handpiece constructed in accordance with the present invention;

FIG. 8 is a view, partly in section, illustrating a dental handpiece constructed in accordance with the present invention driven by an external electrical motor;

FIG. 9 is a fragmentary sectional view illustrating the proximal end of another dental handpiece constructed in accordance with the present invention; and

FIG. 10 is a sectional view illustrating a torsion bar overload coupling for use in a dental handpiece in accordance with the present invention.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

The dental handpiece illustrated in FIG. 1 includes a housing 2 serving at one end (the proximal end) as a handle 2a of a size and configuration to be conveniently graspable by a user, e.g., a dentist or other dental care attendant. The opposite, distal end of housing 2 includes a slender neck 2a carrying a tool clamping section, generally designated 3, to receive a dental tool of a size and configuration enabling the dental tool to be received in the mouth of the patient and to be used for performing an operation therein involved in a dental treatment of the patient. Such dental handpieces are frequently constructed, e.g., as described in my prior U.S. Pat. No. 5,549,474, for selectively receiving various types and sizes of dental drills or other dental tools according to the dental operation to be performed.

The dental handpiece illustrated in FIG. 1 is a battery operated self contained unit. It includes an electrical motor 4 driven by a battery 5 within housing 2. Motor 4 is coupled by a transmission, generally designated 6, to drive the dental tool carried by the clamping device 3.

In accordance with the present invention, the dental clamping device 3 at the distal end of the housing 2 receives a dental tool 7 having a driving tip 8 for engaging the head of a fastening member (not shown) to be fixed by rotation within the patient's mouth. Such a fastening member may be for example an implant to be fixed by rotation in the patient's jawbone. Also in accordance with the present invention, the transmission 6 between the electrical motor drive 4 and the dental tool 7 includes a torque limiter, generally designated 10, for limiting the torque applied by the rotary drive to the driving tip 8.

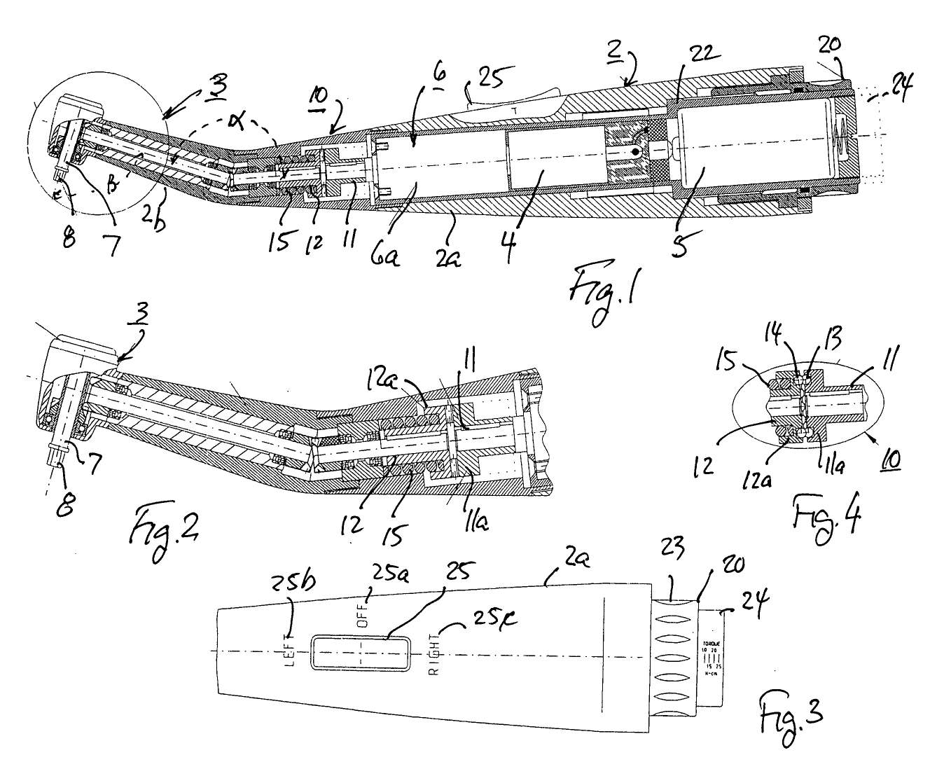

Torque limiter 10 included in the dental handpiece illustrated in FIG. 1 is more particularly illustrated in FIGS. 2 and 4. It includes a drive shaft 11 driven by the electrical motor 4 via section 6a of the transmission system 6, and a driven shaft 12 coupled to the dental tool 7 via another section 6b of the transmission system. The two shafts 11, 12 are each formed with confronting flanges 11a, 12a, respectively, carrying balls 13, 14 (FIG. 4) urged into engagement with each other by a spring 15 acting on the driven shaft 12. Thus, the force applied by spring 15 urging its ball carrying flange 12a into engagement with the ball carrying flange 11a of the drive shaft 11 determines the maximum torque applied by the rotary motor 4 to the driving tip 8 of the dental tool 7, since any torque above that maximum will cause slippage between the two flanges 11a, 12a.

As shown in FIG. 1, the axis of the slender neck portion 2b of housing 2 forms an angle “α” with respect to the axis of the handle portion 2a, and an angle “β” with respect to the tool clamping section 3. Preferably, angle β is 90°, whereas angle α is slightly less than 180° e.g., about 150°.

Torque limiter 10 is located within the distal end of handle 2a and is coupled to the electrical rotary motor 4 by transmission section 6a, e.g., any conventional step-down transmission such as a planetary gearing. The section 6b of the transmission 6 within neck 2b of the housing 2 includes a shaft 16 coupled at one end by bevel gears 17 to the driven shaft 12 of the torque limiter 10 and at the opposite end by bevel gears 18 to the dental tool 7 received within the tool clamping section 3 of the housing.

Handle 2a carries a knob 20 which is manually rotatable in order to preset the maximum torque to be transmitted by the torque limiter 10 to the dental tool 7. As shown in FIG. 1, knob 20 is manually rotatable with respect to housing 2 and is formed at its inner end with threads 21 engageable with corresponding threads in an inner housing 22 containing the battery 5, electric motor 4, and section 6a of the transmission 6 within the handle 2a. The drive shaft 11 of torque limiter 10 is coupled to transmission section 6a within the handle 2a such that rotation of knob 20 in one direction axially displaces the inner housing 22, together with transmission section 6a and shaft 11 of the torque limiter, towards shaft 12 of the torque limiter, to compress spring 15, and thereby to increase the maximum torque capable of being transmitted by the rotary drive motor 4 to the dental tool 7. Rotation of knob 20 in the opposite direction moves torque limiter shaft 11 away from torque limiter shaft 12 to decrease the force applied by spring 15, and thereby decrease the maximum torque capable of being transmitted by the torque limiter.

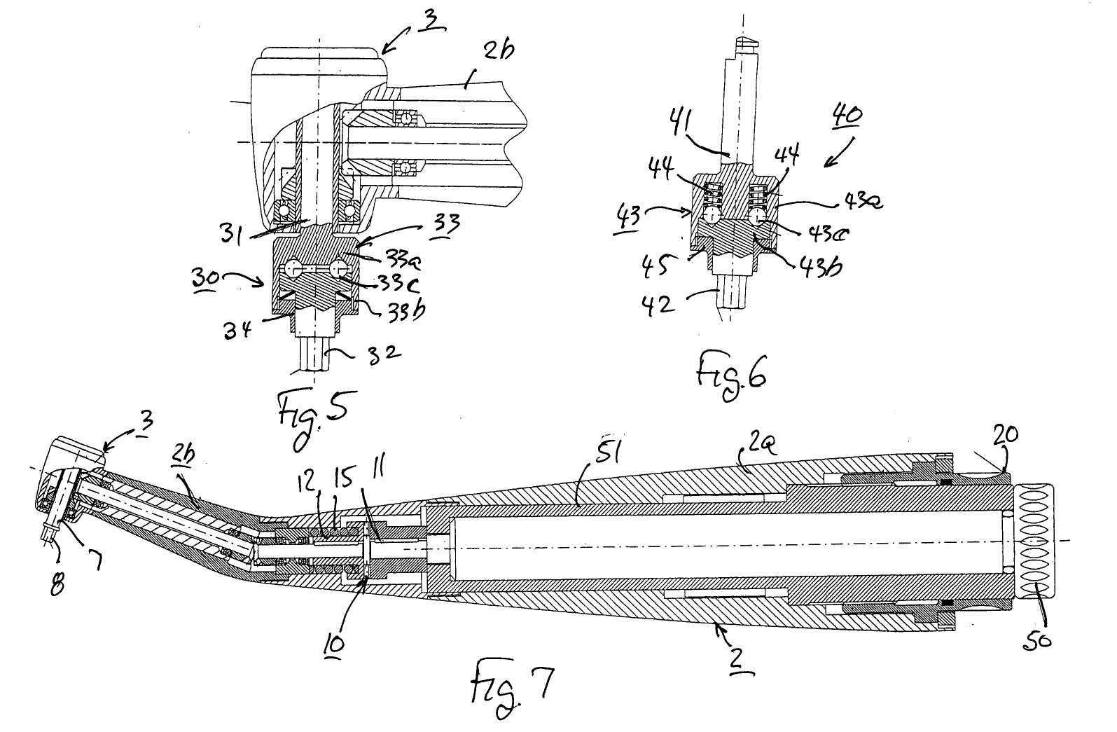

As shown in FIG. 3, knob 20 is formed with finger engaging recesses 23 to facilitate manual rotation of the knob, and with an indicator 24 to indicate the maximum torque presetted by the knob.

As further shown in FIG. 3, handle 2a of the dental handpiece includes a three position toggle switch 25 for controlling the electrical motor drive 4. The neutral position of switch 25 is its OFF position as indicated by indicia 25a; its left position produces a forward drive of the electrical motor 4 to rotate the dental tool 7 in one direction as indicated by indicia 25b; and the right position of electrical switch 25 produces a reverse drive of the electrical motor and thereby applies a torque to the dental tool 7 in the opposite direction as indicated by indicia 25c.

The manner of using the dental handpiece illustrated in FIGS. 1-4 will be apparent from the above description. Thus, whenever a fastening member, such as an implant, is to be fixed by rotation within the patient's mouth, dental tool 7 including the driving tip 8 is received within the tool clamping section 3 of the dental handpiece. For example, the tool clamping section 3 of the dental handpiece may be of the construction as described in the above-cited U.S. Pat. No. 5,549,474, to include a button which is depressible in order to release the dental tool clamped therein, and to permit dental tool 7 including the driving tip 8 to be clamped therein. The tool 7 would thus be driven by the electrical motor 4 via the transmission 6 and torque limiter 10 to rotate the fastening member to be fixed within the patient's mouth.

The use of the dental handpiece for this purpose thus enables fixing the fastening member in a more convenient and speedier manner than the manual manner used at the present time. In addition, the torque limiter 10 limits the torque applied by the rotary drive to the dental tool 7, and thereby to the fastening member engaged by the dental tool, such as to avoid the danger of applying excessive torque and causing damage to the patient.

The maximum torque applied may be preset by rotating knob 20 as described above. Thus, rotating knob in one direction increases the force applied by spring 15 of the torque limiter 10 to thereby increase the maximum torque capable of being transmitted to the dental tool; whereas rotating knob 26 in the opposite direction decreases the force applied by the spring and thereby the maximum torque capable of being transmitted to the dental tool.

FIG. 5 illustrates the invention implemented in the dental tool itself to be selectively applied to the tool clamping section 3 of the dental handpiece whenever it is desired to fix by rotation a fastening member within the patient's mouth. Such a dental tool therefore can be one of many dental tools included in a dental kit to be selectively applied to the dental handpiece whenever needed for a particular dental operation.

The dental tool illustrated in FIG. 5, therein generally designated 30, includes: a mounting shaft 31 at one end for clamping within the tool clamping section 3 of the dental handpiece; a driving tip 32 at the opposite end for engaging the head of the fastening member to be fixed by rotation within the patient's mouth; and a torque limiter 33 between the mounting shaft and the driving tip for limiting the torque capable of being applied to the fastening member engaged by the driving tip.

Torque limiter member 33 in the dental tool illustrated in FIG. 5 is a bellevielle-spring type overload coupling. It includes a drive section 33a coupled to a driven section 33b by a plurality of balls 33c urged together by a bellevielle-spring washer 34 interposed between the driven section 33b and a threaded nut 35. Thus, by threading nut 35 more or less with respect to the driven section 33b, the maximum torque transmitted by torque limiter 33 can be preset as desired.

The invention can also be implemented by providing a dental kit including a dental handpiece as described above together with one or more torque applicator dental tools as illustrated in FIG. 5, each preset for a different torque limit and/or each providing a different type of driving tip 32 to be selected according to the particular dental operation to be performed. Such a kit could also include other dental tools, such as drills of various sizes, also selectively attachable to the tool clamping section of the dental handpiece.

FIG. 6 illustrates the invention implemented in a torque applicator tool therein generally designated 40 also including a mounting shaft 41 at one end coupled to a driving tip 42 at the opposite end by another type of torque limiter 43. In this case torque limiter 43 includes a driving section 43a coupled to a driven section 43b by a plurality of balls 43c which are spring-urged by individual springs 44. The torque limiter illustrated in FIG. 6 also includes a nut 45 which may be threaded more or less with respect to the driven section 43b for presetting the maximum torque capable of being transmitted.

FIG. 7 illustrates the invention implemented in a dental handpiece having a manual drive, rather than an electrical drive, for rotating the fastening member to be fixed by rotation within the patient's mouth. Thus, the dental handpiece illustrated in FIG. 7 is of substantially the same construction as described above with respect to FIGS. 1-4; and therefore to facilitate understanding, the corresponding elements have been identified by the same reference numerals. The dental handpiece illustrated in FIG. 7 however includes a manually rotatable knob 50 instead of the electrical motor 4 for rotating the transmission coupled by the torque limiter 10 to rotate the driving tip 8 for fixing the fastening member. Thus, manually rotatable knob 50 is coupled to the drive shaft 11 of the torque limiter 10 by means of an elongated sleeve 51, such that drive shaft 11 of the torque limiter is rotated manually by rotating knob 50 rather than by the electrical motor in the embodiment of FIGS. 1-4. The dental handpiece illustrated in FIG. 7 also includes the manually presettable knob 20 for presetting the maximum torque capable of being transmitted by the torque limiter in the same manner as described above with respect to FIGS. 1-4.

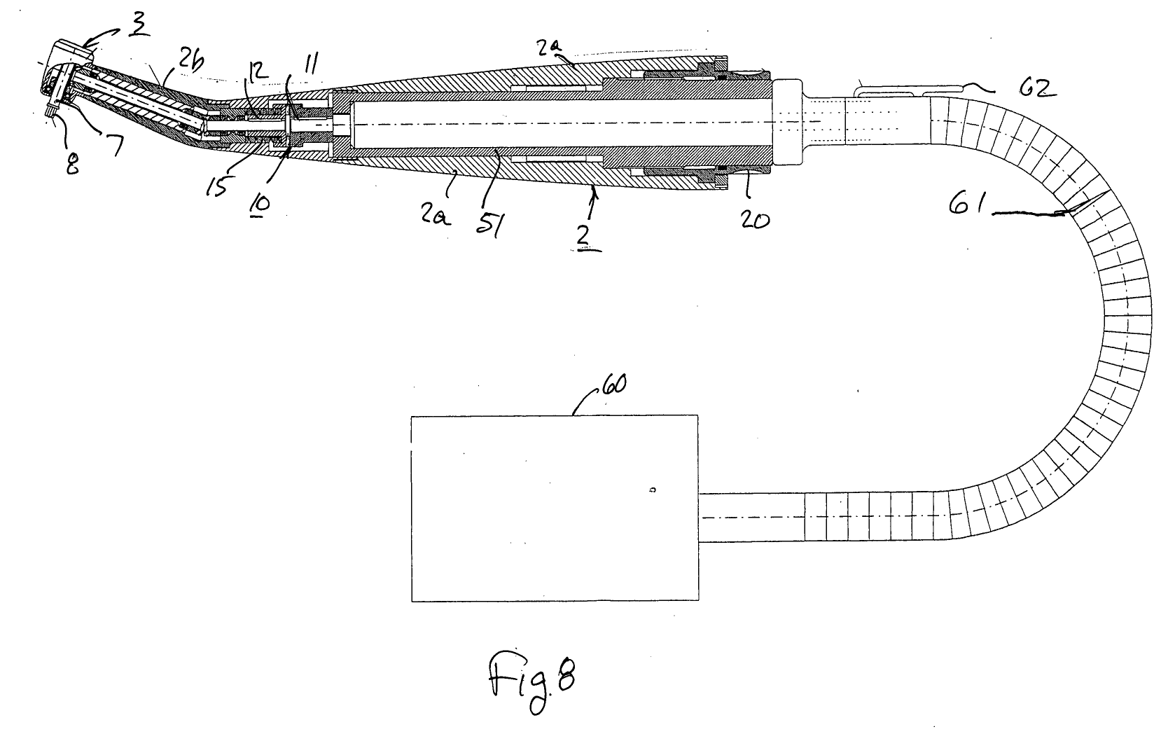

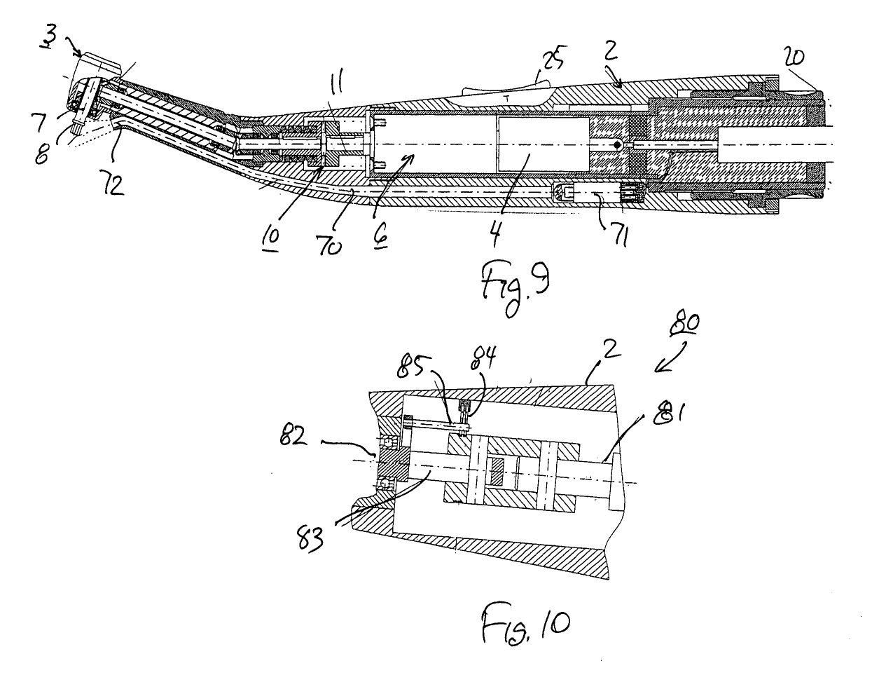

FIG. 8 illustrates a dental handpiece similar to the construction of FIG. 7 except that the inner drive shaft 51 is coupled, not to a manually rotatable knob as in FIG. 7, but rather to an external electrical motor 60 via a flexible drive shaft 61. The drive shaft 61 is conveniently couplable to the dental handpiece by quick release coupling 62.

FIG. 9 illustrates the invention implemented in a dental handpiece which includes a light source for illuminating the working area within the patient's mouth. Thus, as shown in FIG. 9, the dental handpiece includes an optical fiber 70 having one end exposed to a light source 71 and the opposite end 72 oriented to illuminate the region of the fastening member to be fixed by rotation by the driving bit 8. In all other respects the dental handpiece illustrated in FIG. 9 is constructed and operates substantially as described above with respect to FIGS. 1-4, and therefore its various components are identified by the same reference numerals to facilitate understanding.

FIG. 10 illustrates the invention implemented in a motor driven dental handpiece which includes a torsion bar type overload coupling and electrical means for interrupting the operation of the electric motor when the torque is exceeded. The torque limiter illustrated in FIG. 10 and therein generally designated 80, includes a drive section 81 coupled to the motor (e.g., electrical motor 4, FIG. 1), and a driven section 82 coupled to the dental tool (e.g., 7, FIG. 1) to be rotated by the electrical motor. In this case, however, the two sections 81, 82 are coupled together by a torsion bar 83 which becomes deformed according to the torque between the two sections 81, 82. The drive section 81 includes an electrical contact 84 that rotates with the drive section; and the driven section 82 also includes an electrical contact 85 that rotates with that section. The arrangement is such that when the transmitted torque is below the maximum value, electrical contact 85 engages electrical contact 84 to maintain the electrical power to the motor; however, when the transmitted torque exceeds a predetermined maximum, torsion bar 83 is deformed sufficiently to cause its contact 85 to separate from contact 84 carried by the drive section 81 to thereby interrupt the electrical power to the motor.

The torsion bar torque limiter illustrated in FIG. 10 can also be made pressetable by adjusting the axial position of electrical contact 84 with respect to the torsion bar 83. Thus, by presetting electrical contact 84 axially away from the driven section 82, a smaller deformation of the torsion bar 83 will interrupt the electrical connection between contacts 84 and 85; and by displacing the electrical contact 84 axially towards the driven section 82 of the torque limiter, a larger deformation of torsion bar 83 will be required in order to cause separation of the two electrical contacts and thereby an interruption of the electrical power to the motor.

While the invention has been described with respect to several preferred embodiments, it will be appreciated that these are set forth merely for purposes of example, and that many other variations, modifications and applications of the invention may be made.

What is claimed is:

1. A dental handpiece, comprising:
a housing of a size and configuration to be conveniently graspable by a user;
a dental tool clamping device carried by said housing;
a dental tool to be clamped in said clamping device, said dental tool being of a size and configuration enabling it to be received in the mouth of the patient and used for performing an operation therein involved in a dental treatment of the patient;
a rotary drive for rotating said clamping device, and the dental tool when clamped therein;
and a transmission system coupling said rotary drive to said dental tool to rotate same;
characterized in that said dental tool includes a driving tip for engaging the head of a fastening member to be fixed by rotation within the patient's mouth; and in that said transmission system includes a torque limiter for limiting the torque applied by said rotary drive to said driving tip.

2. The dental handpiece according to claim 1, wherein said torque limiter is included within said housing between said rotary drive and said dental tool clamping device.

3. The dental handpiece according to claim 1, wherein said dental tool further includes a mounting shaft at the opposite end with respect to said driving tip receivable within said clamping device and releasably clampable therein.

4. The dental handpiece according to claim 3, wherein said torque limiter is included within said dental tool between said mounting shaft and said driving tip.

5. The dental handpiece according to claim 1, wherein said torque limiter is presettable to limit the torque to be transmitted by said rotary drive to said dental tool clamping device.

6. The dental handpiece according to claim 1, wherein said torque limiter is a bellevielle-spring type overload coupling.

7. The dental handpiece according to claim 1, wherein said torque limiter is a coil-spring type overload coupling.

8. The dental handpiece according to claim 1, wherein said torque limiter is a torsion-bar type overload coupling.

9. The dental handpiece according to claim 1, wherein said rotary drive is an electrical motor drive.

10. The dental handpiece according to claim 9, wherein said torque limiter interrupts the electrical circuit to said motor drive when the applied torque exceeds a predetermined value.

11. The dental handpiece according to claim 1, wherein said rotary drive is a manual drive.

12. The dental handpiece according to claim 1, wherein said dental handpiece further comprises a light source and an optical fiber having one end adjacent to said light source and an opposite end located to illuminate the region of the patient's mouth at which said operation is to be performed when the dental tool is received within the patient's mouth.

13. A tool for mounting to a housing including a rotary drive, comprising:
a driving tip at one end of the tool for engaging the head of a fastening member to be fastened by rotation;
a mounting shaft at the opposite end of the tool for mounting to a housing including a rotary drive;
and a torque limiter between said driving tip and said mounting shaft for limiting the torque to be applied by said rotary drive to said driving tip.

14. The tool according to claim 13, wherein said driving tip is sized and configured for enabling it to be received in the mouth of a patient and used for engaging the head of a fastening member to be fixed by rotation in the patient's mouth.

15. The tool according to claim 14, wherein said torque limiter is presettable to limit the torque to be transmitted by said rotary drive to said driving tip.

16. The tool according to claim 14, wherein said torque limiter is a bellevielle-spring type overload coupling.

17. The tool according to claim 14, wherein said torque limiter is a coil-spring type overload coupling.

18. The tool according to claim 14, wherein said torque limiter is a torsion-bar type overload coupling which actuates an electrical switch when a maximum torque is exceeded.

19. A dental kit comprising:
a housing of a size and configuration to be conveniently grasped by a user;
a rotary drive within said housing;
a dental tool clamping device carried by said housing and coupled to said rotary drive;
and a plurality of different dental tools selectively mountable in said dental tool clamping device for use in various dental treatments of the patient;
at least one of said dental tools including a driving tip for engaging the head of a fastening member to be fixed by rotation within the patient's mouth; and a torque limiter for limiting the torque applied by said rotary drive to said driving tip.

20. The dental kit according to claim 19, wherein said torque limiter is presettable to limit the torque to be transmitted by said rotary drive to said driving tip.
